(19) United States
(12) Patent Application Publication
(10) Pub. No.: US 2014/0314344 A1
(43) Pub. Date: Oct. 23, 2014

(54) Packaging container for bulk materials

(71) Applicant: Nordfolien GmbH, Steinfeld (DE)

(72) Inventor: Michael Kreymborg, Damme (DE)

(73) Assignee: Nordfolien GmbH, Steinfeld (DE)

(21) Appl. No.: 14/256,856

(22) Filed: Apr. 18, 2014

(30) Foreign Application Priority Data
Apr. 18, 2013 (DE) 102013006625.5

(51) Int. Cl. B65D 33/01; B31B 39/00

(52) U.S. Cl. CPC B65D 33/01; B31B 39/00
USPC 383/103; 493/227

(57) ABSTRACT

The requirement consists in designing and producing a packaging container for bulk materials, in particular sacks or bags, made of a flexible plastic film with a venting facility, in a particular simple manner. This requirement is met in that the flexible plastic film is designed, at least in a partial area, in two layers, in that the inner layer of the plastic film comprises inner venting openings, in that the outer layer comprises outer venting openings and in that the inner venting openings and the outer venting openings are spaced apart from each other.

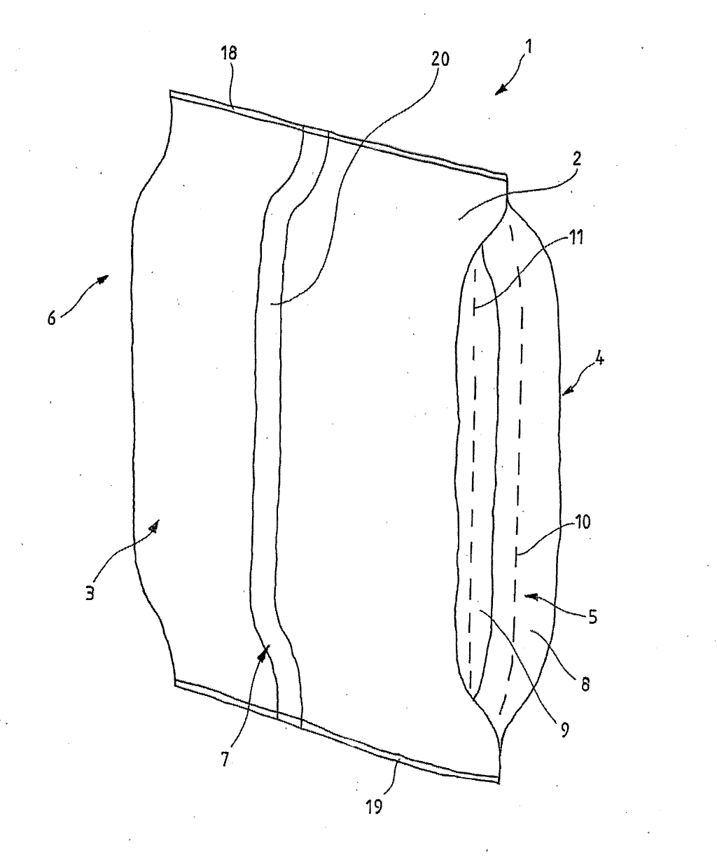

### BACKGROUND OF THE INVENTION

1. Field of the Invention

The invention relates to a packaging container for bulk materials, in particular sacks or bags, made of a flexible plastic film with a venting facility, wherein the flexible plastic film, at least in a partial area, is designed in two layers and in that the inner layer of the plastic film comprises inner venting openings, the outer layer comprises outer venting openings and in that the inner venting openings and the outer venting openings are spaced apart from each other.

2. Brief Discussion of the Related Art

Packaging containers of this kind are intended, in particular, for housing pourable or finely granulated filling materials, such as foodstuffs, fertilisers, granulates or building materials. Filling materials of this kind are produced in various industrial sectors, but then required somewhere else for further processing in a manufacturing process. The packaging container is used for transporting or temporarily storing the filling materials or bulk materials or, in case of an end product stored therein, for offering them on the market. Previously packaging containers of this kind were realised as paper sacks and in some sectors still are, realised as paper sacks. During stacking of such paper containers any air contained in the paper containers can normally escape. Many materials, however, have to be protected against moisture or have to be more efficiently sealed or be treated in a better hygienic manner than is possible with paper. That is why packaging containers made of plastic film are now in widespread use in many fields.

During the filling operation of such packagings a corresponding percentage of air in addition to the filling material gets inside the packaging. In particular when palletizing or stacking such packagings it is possible for an overpressure to arise, which can damage the packaging or tear it open. Adequate venting is therefore imperative.

A packaging container of the kind mentioned in the beginning is known from the DE 1 809 578 A. Herein a sack or bag is described, which consists of at least two layers, wherein each single film layer is provided with perforations, wherein these perforations are laterally offset in the finished sack. The film layers lie loosely on top of each other in the area of the perforations. With this arrangement of the perforations one film layer covers the perforations of the other. In this way it is possible to a large extent, to prevent water from penetrating into the sack and to prevent filling material inside the sack from escaping, whilst air from outside or air enclosed inside the sack through the pneumatic filling operation between the film webs lying loosely on top of each other, can pass from the perforations of the inner film layer to the perforations of the outer layer and vice versa.

The EP 1 607 339 B1 describes a veritable sack which is of double-layer design in a strip in which the film layers are glued together for forming the sack or a circumferential tube. A venting facility is arranged in this double-layer area of the packaging wall, which is formed by perforations and partially sealing transverse seams.

A similar packaging has been described in the DE 10 2006 017 229 B4. Here the wall area is also formed from an inner layer and at least one outer layer, wherein at least one guiding element is arranged between these two layers for the air current passing through the air-permeable sections of the area.

The U.S. 2012/0196060 A1 has disclosed a packaging which comprises a one-way overpressure valve, wherein an air channel is formed between two film layers, with the channel forming an overpressure valve.

### BRIEF SUMMARY OF THE INVENTION

The invention is based on the requirement to propose a packaging container of the kind mentioned in the beginning, which comprises a venting facility which can be manufactured at very little expense. Furthermore the invention is based on the requirement to provide a method for manufacturing such a packaging container.

The solution to the requirement is effected with the characteristics of patent claim 1. As regards the method the solution to the requirement is effected with the characteristics according to patent claim 14. Advantageous designs of the invention are the subject of the sub-claims.

### BRIEF DESCRIPTION OF THE DRAWINGS

The FIGURE illustrates the packaging member of the present invention.

### DETAILED DESCRIPTION OF THE PREFERRED EMBODIMENTS

With a packaging container for bulk materials, in particular a sack or a bag made from a flexible plastic film with a venting facility, wherein the flexible plastic film, at least in partial sections, is designed as two layers, wherein the inner layer of the plastic film comprises inner venting openings, the outer layer of the plastic film comprises outer venting openings and the inner venting openings and the outer venting openings are spaced apart from each other, provision is made according to the invention for the two layers forming the two-layer plastic film to be areally separably connected, at least across the inner venting openings and the outer venting openings such that the two layers do not become detached from each other until an overpressure is created inside the packaging container. As a result a valve is created. The packaging container is closed and moisture cannot penetrate. It is not until an overpressure occurs, for example when stacking such packaging containers, that the two layers of the two-layer plastic film become detached from each other thus facilitating a controlled escape of air from the packaging container without the same bursting open. The venting facility thus created is particularly simple.

The plastic film itself is of a two-layer design. But it is not a case of placing two layers of a plastic film on top of each other in the bag geometry, which would create a thickened region in the bag which would also have an adverse effect upon the winding operation. Rather, the two layers themselves form the plastic film and together comprise the thickness and strength necessary to meet the mechanical demands. It is feasible, admittedly, to impart to each layer a thickness and strength which is sufficient to ensure stability of the packaging container, but this would incur increased avoidable costs. Preferably therefore only the two-layer plastic film as a whole fully meets the mechanical demands made on the stability of the packaging container. The layers of the plastic film are preferably of equal strength and equal thickness. In some embodiments it may be preferable for one of the plastic films to account for 60% or 70% of the total strength and for the other plastic film to account for only 30% or 40% of the total strength. For plastic film layers of different strengths it is preferred if the stronger layer of the plastic film is arranged on the outside of the packaging container. The venting facility is formed within the two-layer plastic film itself. The inner venting openings in the inner layer of the plastic film are spaced apart from the outer venting openings in the outer layer of the plastic film so that a certain air passage through the two connected layers of the plastic film would be necessary. But this also has the effect of preventing air and also moisture from penetrating. The air does not escape until the container is vented and this only happens when due to compression with a stamp a certain pressure coming from inside is present at the inner venting openings. For this purpose the connection of the two layers of the plastic film is designed so as to be separable. This separable connection is preferably implemented as an adhesive connection.

It is feasible that with packaging containers composed of several partial areas either only the topside or only the underside of the bag or the topside and the underside or only the side-folds of the bag are formed from a two-layer plastic film. This would be the case in particular where due to the manufacturing technology the side-folds are inserted separately.

It is, however, especially preferred to manufacture the packaging container in its entirety from a two-layer plastic film. This makes manufacture particularly easy.

The inner layer and the outer layer of the plastic film are preferably formed adhering together without using any aids. An adhesive connection of this kind is without glue and without aids. Such an adhesive connection, which is aid-free, could also be called a dry connection, in particular because there is no liquid in it. This can be achieved in that the layers of film are joined at a raised temperature which however still lies below the welding temperature of the films to be connected with each other. Preferably the films have been areally connected within a temperature range between 30° C. and 100° C., in particular between 30° C. and 90° C., especially particular between 30° C. and 80° C., even better between 30° C. and 70° C., and in particular between 40° C. and 60 C° C. For a peeling test with a clamping length of 25 mm, a specimen width of 15 mm and a parallel specimen length of 100 mm, the adhesive force of the areally connected film layers is preferably 0.1 Newton/15 mm to 0.8 Newton/15 mm, in particular 2 Newton/15 mm to 8 Newton/15 mm and especially preferably 3 Newton/15 mm to 7 Newton/15 mm. Measurements are taken in accordance with DIN 53 357 “Testing of plastic webs and films using the layer separating test”. A strip cutter is used to cut 15 mm wide strips. As a rule this is done in transverse and in longitudinal direction of the film running direction. The specimens are manually separated and the strips are clamped into a tensile test machine and tested (speed 100 mm/min, peeling angle for flexible films 90°). In some embodiments a gluing or adhesive aid or another aid may be used which advantageously supports the adherence between the two layers. The adherence between the two layers is calculated such that the layers adhere together, but separate for an occurring pressure or during venting and due to air entering through the inner venting openings, so that air can pass from the inner venting openings through to the outer venting openings. This is also called “peeling-off” of the two layers. A separating material albeit may be used for the adhering layers, but this is not obligatory. The adhering layers are preferably manufactured, at least on the sides facing each other, from thermoplastics, preferably polyethylene or its copolymers. Thermoplastic elastomers and acrylates or polyurethane are feasible, as well as further adhesion-supporting materials. Individual layers are preferably built up from 2 or 3 layers. But implementations are feasible where individual layers of the film consist of 4, 5, 7, 9 or more layers. The areal connection between the two layers could also be designed in a different way. The connection between the two layers is then designed such that for a venting operation the connection between the inner layer of the plastic film and the outer layer is broken at least in the area between the inner venting openings and the outer venting openings, so that it is possible to perform venting from the inner venting openings through to the outer venting openings between the inner layer and the outer layer of the plastic film. The connection is preferably such that the two layers of the areally connected two-layer plastic film does not break open until the minimum opening pressure inside the packaging container has reached 50 hPa (hectopascal). In a preferred embodiment this breaking-open does not occur until the minimum opening pressure inside the packaging container has reached 100 hPa. Especially preferred is a film connection which does not break open until the minimum opening pressure has reached at least 250 hPa. Typically this minimum opening pressure is achieved by means of pressing bands which generate a corresponding pressure. This minimum opening pressure must be higher by typically 1.013 hPa relative to the ambient pressure.

The inner venting openings and the outer venting openings are preferably evenly distributed across the whole area, in which the packaging container is formed from a two-layer plastic film. Preferably therefore, if a whole wall is formed from a two-layer film, a uniform distribution of the inner and outer venting openings across at least one wall is provided. For a packaging container completely formed from a two-layer plastic film, at least one wall in a preferred embodiment is completely uniformly provided with venting openings, and in another embodiment the entire packaging container is provided uniformly with venting openings.

In a preferred embodiment of the invention the inner venting openings and the outer venting openings are distanced from each other by respectively at least three millimetres, preferably by respectively at least five millimetres and for a design, where the pressure must be even higher in order to allow the air to escape to outside, the inner venting openings and the outer venting openings are distanced from each other by respectively at least 10 or even 20 millimetres. The distribution of the distances is relatively even. This means that the upper limit of the distances is larger, as a rule, by two, three or five millimetres than the minimum distance. Preferably therefore a distribution of distances is from either five to nine millimetres between the inner venting openings and the outer venting openings or for example from 10 to 14 millimetres or from 20 to 25 millimetres. The distances may be up to 450 mm.

In another preferred embodiment of the invention the packaging container comprises side-folds with the inner venting openings and outer venting openings arranged in the side-folds. This is possible both for the embodiment where only the plastic film used in the side-folds is of two-layer design and for the embodiment where the plastic film of the entire packaging container is of two-layer design. The side-fold can be divided into two halves on either side. Preferably the inner venting openings of the inner layer are arranged on one side, and the outer venting openings of the outer layer are arranged in the adjacent area of the side-fold of one side of the bag. For a typically aligned and predefined position of the bag the alignment is preferably such that the outer venting openings are placed in the side-fold lying below, whilst the inner venting openings are placed in the side-fold lying on top. As a result moisture entering from outside would have to migrate to the top, which is obviously difficult. Arranging the venting openings in the side-folds is preferred because this will also essentially simplify venting through compression from the top because it is then easy for the air to escape at the sides. In principle the venting openings may be arranged either on the topside or on the underside.

The venting themselves may be formed in a variety of shapes. Preferably the venting openings are formed as slots. Furthermore several venting openings are preferably provided one above the other in a row. The arrangement of slot-shaped venting openings in particular has the advantage from a manufacturing point of view that these, in contrast to punchings, can be inserted relatively simply into a running film web. In another preferred design the venting openings are formed as perforations.

In a preferred design of the invention the packaging container comprises at least one strip-shaped area, in which the plastic film is overlapping, wherein the venting facility is arranged outside this strip-shaped area. For manufacture the plastic film is typically connected in a tube-like manner. To this end the two ends are placed and glued or welded together in an overlapping area. This is the area in which according to the prior art the venting facility is typically arranged. For this purpose this area must be a comparatively wide area. With the invention the venting facility is arranged outside this strip-shaped area. The strip-shaped area in which the plastic film is overlapping may therefore be comparatively narrow and it can also be placed anywhere, and thus has very little influence upon the printed image and the whole appearance of the packaging container. It is also preferred if the strip-shaped area is connected only by a glued seam. If a channel for a venting facility is formed in the strip-shaped area, then at least two spaced-apart gluing strips, bonds or welds are necessary, thus requiring more corresponding longitudinal web material.

With a method for manufacturing the above-mentioned packaging container it is essential according to the invention that venting openings are inserted in a first plastic film section, venting openings are inserted in a second plastic film section, and that the first plastic film section and the second plastic film section, following insertion of the venting openings, are joined to form a two-layer plastic film, wherein the two plastic film sections adhere to one another, and the above-mentioned packaging container is formed from the thus formed plastic film.

The first plastic film section and the second plastic film section may be separate webs or may be one continuous web which is folded or joined after insertion of the venting openings. It is essential, however, that the venting openings of the first plastic film section do not exactly lie on top of the venting openings of the second plastic film section.

Preferably the placing together of the plastic film sections is effected at temperatures of about 30° C., preferably at temperatures between 30° C. and 100° C., in particular between 40° C. and 60° C. Also temperatures between 30° C. and 90° C., 30° C. and 80° C. and 30° C. and 70° C. may be preferred. At these temperatures the films are not welded, but adherence is achieved. This applies in particular to polyethylene and preferably also to LDPE, i.e. low-density-polyethylene films. It is preferred to use these. An adherence of the thus formed two-layer plastic film is thus achieved. When applying pressure the layers separate from each other by way of peeling off and thus venting takes place.

The invention will now be described in detail with reference to the preferred exemplary embodiment shown in the schematic drawing.

A packaging container, here with side-folds, is marked with 1 and this comprises a plastic film 2 enveloping the filling material. The packaging container comprises a front wall 3 formed from the plastic film 2, a rear wall 4 as well as two side walls 5 and 6 which constitute the side-folds. In the front wall 3 of the packaging container 1 an overlapping area 7 is shown, in which during the production process the ends of a film web are typically placed on top of each other and connected. In the packaging container 1 according to the invention the venting openings may be arranged in a random place outside the connection area 7. The connection area 7, in the shown embodiment, may be randomly narrow. The one and only condition is that the film webs are connected with each other. It is not necessary to arrange the venting area in this overlapping area 7. The upper layer in this connection area is marked with 20. When the whole of the packaging container consists of a two-layer plastic film, then the overlapping area 7 is four-layer because each two layers are areally connected with each other in an adhering manner. The overlapping area may comprise widths of between 20 mm and 30 mm. This is sufficient for ensuring a safe bond of the plastic film. With a design of the overlapping area according to the prior art the usual widths employed were between 80 mm and 140 mm. These two areally adhering layers constitute a plastic film. The two superimposed end regions of each two-layer plastic film are connected with each other in the overlapping area 7 by gluing or welding. The venting facility is formed here from slop-shaped venting openings 10, which are arranged in the lower side-fold 8 of the side wall 5 and are arranged solely in the outer layer of the two-layer plastic film 2. The associated inner venting openings 11 also shaped as slots are arranged exclusively in the inner layer of the two-layer plastic film 2 and are not really visible in the figure since they are covered by the outer layer, but are drawn here for making this clear. Here these slots are arranged in the upper side-fold 9 of the side wall 5. For a packaging container 1 normally stored lying down any moisture penetrating from outside would therefore have to travel vertically upwards from the outer venting openings 10 to the inner venting openings 11. Thus an effective protection against moisture is ensured. At the same time venting is possible. Preferably similar venting openings are additionally arranged in the second side-wall 6. At the top the packaging container 1 is closed by an upper transverse seam 18 and at the bottom it is closed by a lower transverse seam 19. Since the venting openings may be continuously inserted into the plastic film 2, any desired length is possible for the packaging container 1 without having to take into account any special designs as regards a possible chamber-like venting facility.

All characteristics mentioned in the above invention and in the claims can be combined freely with the characteristics of the independent claim. The disclosure of the invention is thus not limited to the described or claimed feature combinations, rather all meaningful feature combinations in terms of the invention are to be regarded as disclosed.

1. A packaging container for bulk materials, in particular sacks or bags, made from a flexible plastic film with a venting facility,
wherein the flexible plastic film is configured as a two-layer film at least in a partial area, and the inner layer of the plastic film comprises inner venting openings, the outer layer of the plastic film comprises outer venting openings and the inner venting openings and the outer venting openings are arranged at a distance from each other, wherein the two layers which form the two-layer plastic film are areally separably connected at least across the inner venting openings and the outer venting openings in such a way that the two layers do not separate from each other until an overpressure is created inside the packaging container.

2. The packaging container according to claim 1, wherein at least one wall of the packaging container is formed from the two-layer plastic film.

3. The packaging container according to claim 1, wherein the packaging container as a whole is formed from a two-layer plastic film.

4. The packaging container according to claim 1, wherein the inner venting openings and the outer venting openings are uniformly distributed across the entire area, in which the packaging container is formed from a two-layer plastic film.

5. The packaging container according to claim 1, wherein the two layers of the areally connected two-layer plastic film do not separate from each other until a minimum opening pressure of at least 50 hPa has been reached inside the packaging container.

6. The packaging container according to claim 1, wherein the inner venting openings and the outer venting openings are arranged spaced apart from each other by at least three millimetres respectively.

7. The packaging container according to claim 1, wherein the inner layer of the plastic film and the outer layer of the plastic film are designed so as to adhere to one another without any aids.

8. The packaging container according to claim 1, wherein the two layers of the plastic film, at least on the sides facing each other, are formed from polyethylene or copolymers thereof.

9. The packaging container according to claim 1, wherein the packaging container comprises side-folds and the inner venting openings and the outer venting openings are arranged in a side-fold.

10. The packaging container according to claim 1, wherein the venting openings are shaped as slots and several slot-shaped venting openings are present in a row one behind the other.

11. The packaging container according to claim 1, wherein the packaging container comprises at least one strip-spaced area in which the plastic film overlaps, and the venting openings are arranged outside this strip-shaped area.

12. The packaging container according to claim 1, wherein the packaging container comprises at least one strip-spaced area in which the plastic film overlaps, and the overlapping plastic films are connected with each other only by a glued seam.

13. The packaging container according to claim 1, wherein the connection of the two layers of the two-layer plastic film is designed such that the connection becomes separated during a venting operation resulting in venting taking place from the inner venting openings through to the outer venting openings between the two layers of the two-layer plastic film.

14. A method for manufacturing a packaging container according to claim 1, where venting openings are inserted in a first plastic film section, venting openings are inserted in a second plastic film section, the first plastic film section and the second plastic film section are joined following insertion of the venting openings for forming a flexible plastic film, and the packaging container is formed from the thus manufactured plastic film.

15. The method according to claim 14, wherein the joining of the first plastic film section and the second plastic film section is effected at temperatures between 30° C. and 100° C., in particular between 40° C. and 60° C.
